(19) United States
(12) Patent Application Publication
(10) Pub. No.: US 2007/0153040 A1
(43) Pub. Date: Jul. 5, 2007

(54) Installing unit for data recording/reproducing device and photo-printer having the same

(75) Inventors: Ju-hyun Park, Suwon-si (KR); Yong-hyun Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/505,502

(22) Filed: Aug. 17, 2006

(30) Foreign Application Priority Data
Jan. 4, 2006 (KR) 2006-998

(51) Int. Cl. B41J 29/38

(52) U.S. Cl. 347/14

(57) ABSTRACT

An installing unit to stably install a data recording/reproducing device, such as a hard disk drive (HDD) into a photo-printer body, and a photo-printer having the installing unit are provided. The installing unit includes: a supporting bracket to support the data recording/reproducing device; a first vibration prevention member to support the supporting bracket to the photo-printer body to prevent an impact generated from the photo-printer from being transmitted to the supporting bracket; and a second vibration prevention member disposed between the supporting bracket and the data recording/reproducing device to absorb the impact transmitted from the supporting bracket to the data recording/reproducing device.

### CROSS-REFERENCE TO RELATED APPLICATION

This application claims all benefits accruing under 35 U.S.C §119 from Korean Patent Application No. 2006-998 filed on Jan. 4, 2006, in the Korean Intellectual Property Office, the disclosure of which is incorporated herein by reference.

### BACKGROUND OF THE INVENTION

1. Field of the Invention

Aspects of the present invention relate to a photo-printer. More particularly, aspects of the present invention relate to an installing unit to install a data recording/reproducing device, such as a hard disk drive (HDD), into a photo-printer to print photographs, and a photo-printer having an installing unit to install a data recording/reproducing device.

2. Description of the Related Art

A typical photo-printer is known to employ a printing technique, such as an inkjet scheme, a dye sublimation thermal transfer scheme or a direct thermal scheme to print images photographed by digital cameras. Such a photo-printer includes a printing unit, namely, a printing engine, to print an image, and a feeding roller to feed a printable medium. The printing unit can correspond to an inkjet head of an inkjet printer, or can correspond to a thermal printing head (TPH) of a dye sublimation thermal transfer printer or a direct thermal printer.

Similar to a conventional laser color printer or an inkjet printer, the photo-printer typically has an interface unit to transmit data, via a wire or wireless transmission channel, to a personal computer (PC) or a photographing device, such as a digital camera, so that the photo-printer can receive a photographed image from the PC or the photographing device and print the image onto a printable medium. Also, similar to a digital camera, the photo-printer is typically compact and light-weight so that it is handy to carry. Accordingly, it is possible to transmit an image photographed by a photographing device to a photo-printer and directly print the image, while carrying the photo-printer together with a photographing device.

However, if the photo-printer is carried, it can be difficult to receive, for example, a photo-album function or an editing function that can typically be received only through a PC. Accordingly, the photographed image received from the photographing device can be printed only by basic functions provided from the photo-printer.

Therefore, a high capacity storage medium, such as a hard disk drive (HDD), has been installed into the photo-printer, so that various editing functions and various data storage capacity can be provided, and the convenience of user can be enhanced. However, the HDD is usually very susceptible to an external impact, and the portable photo-printer can be easily influenced by impact or vibration. As a result, there is a need for an apparatus or a structure to protect the HDD from impact.

### SUMMARY OF THE INVENTION

Accordingly, several example embodiments and aspects of the present invention address the above and other problems, as well as provide various advantages, including, but not necessarily limited to, those advantages herein described. Therefore, an object, among objects, of the present invention is to provide an installing unit that can protect a data recording/reproducing device, such as a hard disk drive (HDD), from an impact, and a photo-printer having an installing unit to install the data recording/reproducing device.

To achieve the above-described and other aspects of the present invention, there is provided an installing unit to install a data recording/reproducing device into a photo-printer body. The installing unit includes: a supporting bracket to support the data recording/reproducing device; a first vibration prevention member to support the supporting bracket on, or with respect to, the photo-printer body to prevent an impact generated from the photo-printer from being transmitted to the supporting bracket; and a second vibration prevention member disposed between the supporting bracket and the data recording/reproducing device to absorb the impact transmitted from the supporting bracket to the data recording/reproducing device.

The first vibration prevention member can include, according to aspects of the present invention, a plurality of vibration proof rubbers engaged with the photo-printer body to support the supporting bracket. The vibration proof rubber can be configured as a cylinder having a hollow portion and having at an outer circumference a circumferential recess to be inserted in the supporting bracket. The photo-printer body can have a connection boss to be inserted in the hollow portion. The hollow portion can have at an inner circumferential surface protruding portions to reduce a contact area with the connection boss. The protruding portions can be formed on the inner circumferential surface of the hollow portion to be parallel with a height direction of the vibration proof rubber.

According to aspects of the present invention, the vibration proof rubber can have an upper part and a lower part with same or different diameters based on the circumferential recess. The vibration proof rubber can be provided in a quantity of four, by way of example, and each pair of vibration proof rubbers can be respectively disposed at both edges of the supporting bracket. The photo-printer body can include a lower case having a driving unit to print an image, and a top cover covering the lower case.

The data recording/reproducing device, according to aspects of the present invention, can be supported by the top cover. The second vibration prevention member, according to aspects of the invention, can include a viscoelastic material, or other suitable material, disposed between the supporting bracket and the data recording/reproducing device. The viscoelastic material can be sprayed on a surface of the supporting bracket, for example.

The supporting bracket, according to aspects of the present invention, can include a body of a plate shape configuration, a bent portion bent from edges of the body to support a side of the data recording/reproducing device, and an engagement portion extending in a horizontal direction from the edges of the body to be inserted into the first vibration prevention member. The data recording/reproducing device can include, by way of example, a hard disk drive (HDD).

To achieve the above-described and other aspects of the present invention, there is provided a photo-printer including: a photo-printer body having a printing engine; a data recording/reproducing device installed in the photo-printer body to record and reproduce data; and an installing unit to install the data recording/reproducing device into the photo-printer body.

The photo-printer body, according to aspects of the present invention, can include a lower case having the printing engine to print an image, and a top cover covering the lower case to support the data recording/reproducing device. The data recording/reproducing device can include a hard disk drive (HDD), by way of example. Also, according to aspects of the present invention, the installing unit can include: a supporting bracket to support the data recording/reproducing device; a first vibration prevention member to support the supporting bracket on, or with respect to, the photo-printer body to prevent an impact generated from the photo-printer from being transmitted to the supporting bracket; and a second vibration prevention member disposed between the supporting bracket and the data recording/reproducing device to absorb the impact transmitted from the supporting bracket to the data recording/reproducing device.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view schematically illustrating a photo-printer according to an example embodiment of the present invention;

FIG. 2 is a perspective view illustrating a top cover and an installing unit of the photo-printer shown in FIG. 1;

FIG. 3 is an exploded perspective view of the top cover and the installing unit shown in FIG. 2;

FIG. 4 is a cross-sectional view of the top cover and the installing unit shown in FIG. 2;

FIGS. 5A and 5B are each a perspective view and a cross-sectional view of a first vibration prevention member, according to an embodiment and aspects of the present invention;

FIG. 6 is a view illustrating another example of the first vibration prevention member according to an embodiment and aspects of the present invention; and

FIG. 7 is a graph illustrating data obtained by experiments on vibration attenuation according to whether a second vibration prevention member is present or not present in an installing unit according to example embodiments and aspects of the present invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

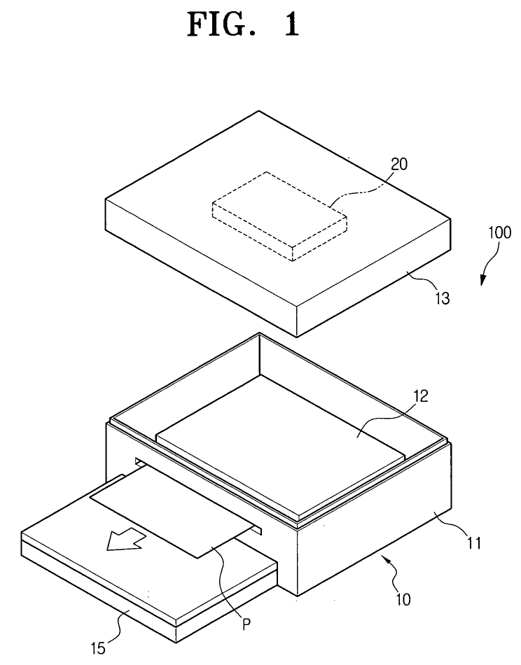

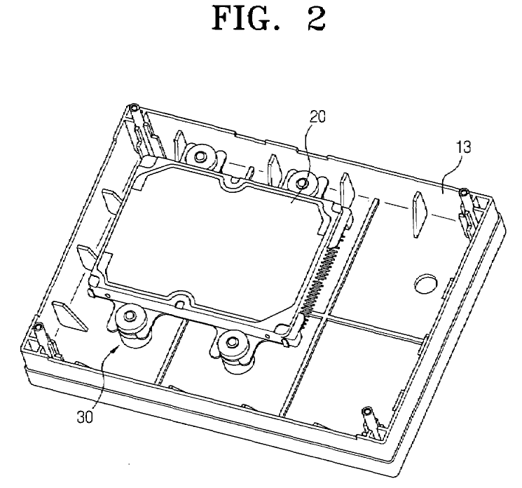

Referring to FIGS. 1 and 2, a photo-printer 100 according to an example embodiment of the present invention includes a photo-printer body 10, a data recording/reproducing device 20 installed into the photo-printer body 10, and an installing unit 30 to install the data recording/reproducing device 20 into, or in engagement with, the photo-printer body 10. The photo-printer body 10 includes a lower case 11 and a top cover 13 to cover a top portion of the lower case 11. The lower case 11 includes a printing engine 12. The printing engine 12 prints an image photographed by a digital camera onto a photo printable paper P, or other suitable media, such as film type media or media for overheads or transparencies, and can include a thermal printing head (TPH) of an inkjet head, a dye sublimation thermal transfer or a direct thermal printer. Also, in FIG. 1, a paper cassette 15 is further included in the photo-printer 100 to feed individual sheets of the printable media into the photo-printer body 10 for a photo-printing operation.

The data recording/reproducing device 20 records data and reproduces the recorded data, and, by way of example, can be a hard disk drive (HDD), although the present invention is not limited in this regard. By way of example, the data recording/reproducing device 20 can include software modules, processors, software and/or firmware readable by one or more processors, or application specific integrated circuits (ASICs), such as associated with machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs), or carrier waves.

Hereafter, the data recording/reproducing device 20 will be described, by way of example, with reference to a HDD, as the HDD 20. The HDD 20 typically has a high capacity of storage so as to provide various application programs to edit photographed images stored in the HDD 20. The HDD 20, with a high capacity of storage, a high density and a high speed, for example, can be susceptible to exterior impacts and vibrations. Therefore, when the HDD 20 is installed, the installing unit 30, according to aspects of the present invention, is used to minimize the impacts received from the photo-printer body 10.

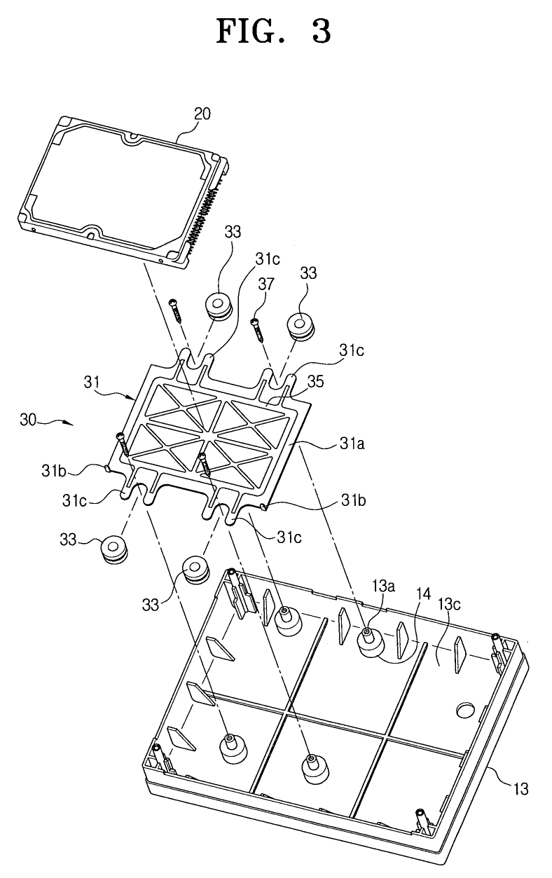

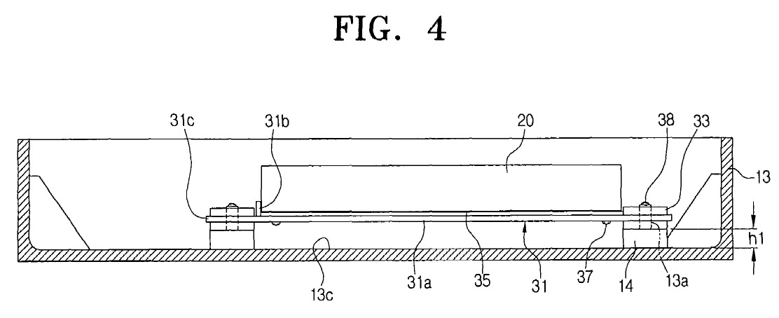

The HDD 20 can be supported, such as by the top cover 13, to minimize a transmission of vibration generated when the printing engine 12 is driven. The installing unit 30 installs the HDD 20 to the top cover 13, and includes a supporting bracket 31, a first vibration prevention member 33 and a second vibration prevention member 35, such as shown in FIGS. 3 and 4, for example.

Continuing with reference to FIGS. 1 through 4, the supporting bracket 31 includes a body 31a having a plate shape configuration, a bent portion 31b bent from an edge of the body 31a to support a side of the HDD 20, and an engagement portion 31c extending from side edges of the body 31a. The supporting bracket 31 is typically made of a metal material and has a predetermined thickness, although other suitable materials can be used for the supporting bracket, such as a plastic type material, for example. The engagement portion 31c is typically provided in a plurality of engagement portions, such as the four engagement portions 31c illustrated in FIG. 3, for example, and each engagement portion 31 is respectively inserted in the first vibration prevention member 33. In this regard, the engagement portion(s) 31c serve(s) as (a) supporting point(s) in the connection of the HDD 20 with the top cover 13. The supporting bracket 31 engages with the HDD 20, such as by screws 37, or other suitable fastening device, with the second vibration prevention member 35 disposed between the HDD 20 and the supporting bracket 31.

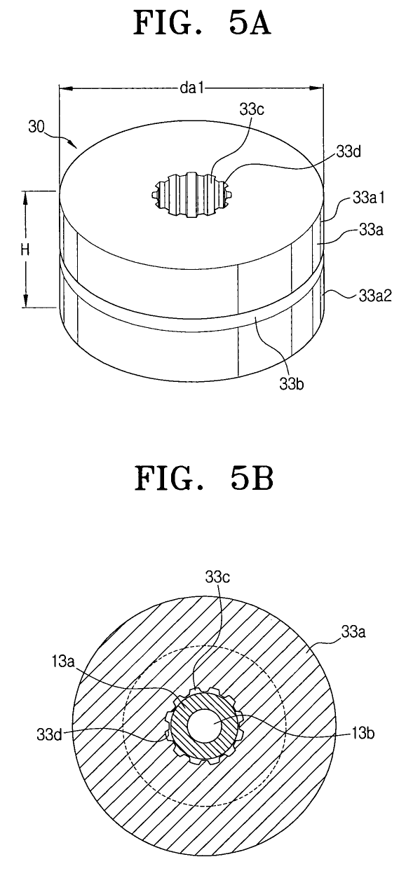

The first vibration prevention member 33 typically includes a vibration proof rubber, or other suitable material, such as a rubber, a plastic or an elastomeric type material, to connect the supporting bracket 31 with the top cover 13. The first vibration prevention member 33 is typically provided in a quantity of four vibration prevention members, such as by a plurality of vibration proof rubbers, for example. The first vibration prevention member 33 has, by way of example, at an outer circumference of the body 33a, a circumferential recess 33b of a predetermined depth, such as shown in FIG. 5A. Also, the first vibration prevention member 33 in the example embodiment of FIGS. 5A and 5B has an upper part 33a1 and a lower part 33a2 with same diameters da1, based on the circumferential recess 33b. The connection portion 31c of the supporting bracket 31 is inserted into the circumferential recess 33b. A hollow portion 33c is formed on and through a center of the body 33a. The hollow portion 33c upwardly and downwardly penetrates the body 33a. Into the hollow portion 33c, a connection boss 13a inside of the top cover 13 is inserted.

When the connection boss 13a is inserted in the hollow portion 33c, protruding portions 33d formed on an inner circumference of the hollow portion 33c minimize the contact area of the connection boss 13a with the first vibration prevention member 33, such as shown in FIG. 5B. The protruding portions 33d typically are formed in parallel with a height direction H of the body 33a, and can be in a stripe pattern or other suitable pattern, for example, such as illustrated in FIGS. 5A and 5B. Therefore, according to aspects of the present invention, if the protruding portions 33d are formed on the hollow portion 33c, the contact portion between the connection boss 13a and the hollow portion 33c can be reduced. Accordingly, the transmission of the impact of the top cover 13 through the connection boss 13a to the vibration reducing member 33 can be minimized.

The connection boss 13a has a screw opening 13b, or other suitable aperture, to be engaged with a screw 37 or other suitable fastener. Accordingly, if the screw opening 13b is fastened with the screw 37, as the first vibration prevention member 33 is engaged with the connection boss 13, the vibration prevention member 33 is not separated from the connection boss 13a. Also, according to aspects of the present invention, the connection boss 13a is typically formed integrally with the top cover 13, or can be otherwise suitably attached or fastened with the top cover 13. Further, the connection boss 13a is connected or engaged with a supporting portion 14 that typically has a diameter greater than the connection boss 13a, so that the supporting bracket 31 can be engaged with the top cover 13 to be in spaced relation, or apart from, the inside 13c of the top cover 13 by a predetermined distance h1. Accordingly, since the first vibration prevention member 33 is engaged with the connection boss 13a positioned above the supporting portion 14, the supporting bracket 31 can be supported in spaced relation, or apart from, the inside 13c of the top cover 13. Thus, by the connection boss 13a being engaged with the first vibration prevention member 33, according to aspects of the present invention, transmission of vibration or transmission of an impact to the top cover 13 directly to the HDD 20 can be substantially reduced or minimized.

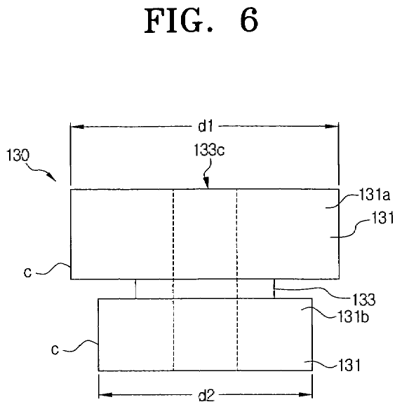

FIG. 6 is a view illustrating a first vibration prevention member 130 according to another example embodiment of the present invention. The first vibration prevention member 130, similar to the first vibration prevention member 33, is made of a vibration proof rubber, or other suitable material, such as a rubber, a plastic or an elastomeric type material. A circumferential recess 133 is formed along an outer circumference C of a body 131 of the first vibration prevention member 130, and the first vibration prevention member 130 has an upper part 131a and a lower part 131b with different diameters d1 and d2, respectively, based on the circumferential recess 133. Also, similar to the first vibration prevention member 33, the connection portion 31c of the supporting bracket 31 is inserted into the circumferential recess 133 of the first vibration prevention member 130. A hollow portion 133c is formed on and through a center of the body 131. The hollow portion 133c upwardly and downwardly penetrates the body 131. Into the hollow portion 133c, the connection boss 13a inside of the top cover 13 is inserted. Further, similar to the first vibration prevention member 33, the protruding portions can be formed on the hollow portion 133c, so that the contact portion between the connection boss 13a and the hollow portion 133c can be reduced, according to aspects of the present invention.

As illustrated in FIGS. 3 and 4, the second vibration prevention member 35 is disposed between the HDD 20 and the supporting bracket 31 and can include a viscoelastic material such as silicone, or other suitable material. In this regard and by way of example, the second vibration prevention member 35 can also be formed of a material of a gel type and can be sprayed on one surface of the supporting bracket 31 that faces the HDD 20. According to aspects of the present invention, by positioning the second vibration member 35 between the supporting bracket 31 and the HDD 20, as the supporting bracket 31 is engaged with the HDD 20, a gap between the supporting bracket 31 and the HDD 20 is significantly minimized. Accordingly, according to aspects of the present invention, vibrations or impacts transmitted through the supporting bracket 31 to the HDD 20 are further attenuated or minimized by the second vibration prevention member 35 so that the HDD 20 can be protected from such vibrations or impacts.

According to the illustrated and described example embodiments and aspects of the present invention, the HDD 20 is installed into the photo-printer body 10 so that the photo-printer 100 can provide not only functions of a printer, but can also provide editing and application programs of high capacity, as well as can provide a high data storage capacity. Therefore, according to aspects of the present invention, even when the photo-printer 100 is carried, various photo data can be held, so that received photo data and stored photo data can be edited and printed.

Additionally, according to aspects of the present invention, the HDD 20 is typically installed into the top cover 13 of the photo-printer body 10 so that the HDD 20 can be installed into the photo-printer 100 in spaced relation, or apart from, the lower case 11 which can include vibration generating components or resources. Furthermore, according to aspects of the present invention, the HDD 20 is typically installed into the top cover 13 using the installing unit 30, as described in the example embodiments, so that the HDD 20 can be protected from not only vibrations of the photo-printer 100 itself, but also from exterior impacts to the photo-printer 100. In this regard and by way of example, the second vibration prevention member 35 is typically disposed between the HDD 20 and the supporting bracket 31 so that more effective vibration prevention can be obtained. The following Table 1 includes experimental data to illustrate that vibration can be significantly reduced according to aspects of the present invention.

TABLE 1

| | | Thickness | Second | |
|---|---|---|---|---|
| | | of | vibration | Vibration |
| | First vibration | supporting | prevention | acceleration |
| Section | prevention member | bracket | member | level (dB) |
| | First comparative | 1.55 mm | None | 98.2 |
| | example | | | |
| | Second comparative | 1.55 mm | None | 96.5 |
| | example | | | |
| | Third comparative | 0.8 mm | None | 95.4 |
| | example | | | |
| | Fourth comparative | 1.55 mm | Yes (1.4 mm) | 94.7 |
| | example | | | |

In the above Table 1, the first, second and third comparative examples show the vibration acceleration level measured from the HDD 20 with each of the respective first vibration prevention members 33 and/or 130 and without the second vibration prevention member 35. Additionally, the vibration acceleration level is measured as the thickness of the supporting bracket 31 varies. As can be seen from the Table 1, even as the thickness of the supporting bracket 31 becomes relatively thin, the vibration can be reduced, according to aspects of the present invention. Similar to the example embodiments of the present invention, as illustrated in the fourth comparative example of Table 1, when the second vibration prevention member 35, such as of a predetermined thickness, is disposed between the HDD 20 and the supporting bracket 31, according to aspects of the present invention, the vibration can be significantly reduced.

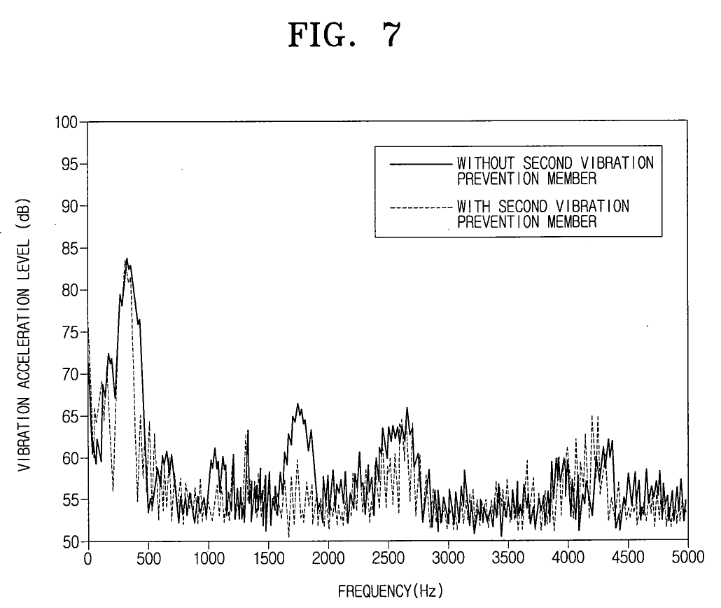

FIG. 7 is a graph illustrating data obtained by experiments on vibration attenuation according to whether a second vibration prevention member is present or not present in an installing unit according to example embodiments and aspects of the present invention. Additionally, as can be understood from the experimental data in the graph of FIG. 7, the vibration acceleration levels in certain frequency bands are very significantly different according to whether the second vibration prevention member 35 is present or not present.

As described, the data recording/reproducing device, such as a HDD, can be stably installed into the photo-printer according to embodiments and aspects of the present invention. Accordingly, according to aspects of the present invention, transmission of vibrations or impacts to the data recording/reproducing device, such as a HDD, can be minimized. In this regard, for example, the effects of vibrations generated from the photo-printer itself and the impacts received to the photo-printer from the outside on the data recording/reproducing device can be minimized. Therefore, according to aspects of the present invention, the data recording/'reproducing device, such as a HDD, can be stably protected and normally operated.

Also, as described, according to aspects of the present invention, the data recording/reproducing device, such as a HDD, is typically installed into or engaged with the top cover of the photo-printer, so that the data recording/reproducing device, such as a HDD, can be in spaced relation, or apart from, the printing engine, to position the data recording/reproducing device as far as possible, or a substantial distance from, the printing engine that typically has most of the driving parts of the photo-printer. Accordingly, stability from vibrations can be obtained. Furthermore, according to aspects of the present invention, the second vibration prevention member is typically disposed between the data recording/reproducing device, such as a HDD, and the supporting bracket so that the vibration can be more effectively reduced.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. For example, the installing unit can include both the first and second vibration prevention members, or can include the first vibration prevention member, such as illustrated in Table 1. Further, the data recording/reproducing device 20, such as a HDD, can also include, for example, software modules, processors, software and/or firmware readable by one or more processors, or application specific integrated circuits (ASICs), such as associated with machine-readable storage media or carrier waves. Accordingly, it is intended, therefore, that that present invention not be limited to the various example embodiments disclosed, but that the present invention includes all embodiments falling within the scope of the appended claims.

What is claimed is:

1. An installing unit to install a data recording/reproducing device on a photo-printer body, the installing unit comprising:
a supporting bracket to support the data recording/reproducing device;
a first vibration prevention member to support the supporting bracket on the photo-printer body to reduce transmission of an impact or a vibration generated from the photo-printer to the supporting bracket; and
a second vibration prevention member disposed between the supporting bracket and the data recording/reproducing device to absorb the impact or the vibration transmitted from the supporting bracket to the data recording/reproducing device.

2. The installing unit as claimed in claim 1, wherein the photo-printer body comprises:
a lower case including a driving unit to print an image; and
a top cover to cover the lower case,
wherein the data recording/reproducing device is supported by the top cover.

3. The installing unit as claimed in claim 1, wherein the second vibration prevention member comprises a viscoelastic material disposed between the supporting bracket and the data recording/reproducing device.

4. The installing unit as claimed in claim 3, wherein the viscoelastic material is sprayed on a surface of the supporting bracket.

5. The installing unit as claimed in claim 1, wherein the supporting bracket comprises:
a body comprising a plate shape configuration;
a bent portion bent from edges of the body to support a side of the data recording/reproducing device; and
an engagement portion extended in a horizontal direction from the edges of the body to insert into the first vibration prevention member.

6. A photo-printer, comprising:
a photo-printer body including a printing engine;
a data recording/reproducing device installed on the photo-printer body to record and reproduce data; and
an installing unit to install the data recording/reproducing device into the photo-printer body.

7. The photo-printer as claimed in claim 6, wherein the photo-printer body comprises:
a lower case including the printing engine; and
a top cover to cover the lower case and to support the data recording/reproducing device.

8. The photo-printer as claimed in claim 6, wherein the installing unit comprises:
a supporting bracket to support the data recording/reproducing device;
a first vibration prevention member to support the supporting bracket on the photo-printer body to reduce transmission of an impact or a vibration generated from the photo-printer to the supporting bracket; and
a second vibration prevention member disposed between the supporting bracket and the data recording/reproducing device to absorb the impact or a vibration transmitted from the supporting bracket to the data recording/reproducing device.

9. The photo-printer as claimed in claim 8, wherein the first vibration prevention member comprises a plurality of vibration proof rubbers engaged with the photo-printer body to support the supporting bracket.

10. The photo-printer as claimed in claim 8, wherein the vibration proof rubber is configured as a cylinder with a hollow portion, and includes, at an outer circumference, a circumferential recess to engage with the supporting bracket.

11. The photo-printer as claimed in claim 10, wherein the photo-printer body comprises a connection boss to engage with the hollow portion of the respective vibration proof rubber.

12. The photo-printer as claimed in claim 11, wherein the hollow portion of the vibration proof rubber comprises, at an inner circumferential surface, protruding portions to reduce a contact area with the connection boss.

13. The photo-printer as claimed in claim 8, wherein the supporting bracket comprises:
a body comprising a plate shape configuration;
a bent portion bent from edges of the body to support a side of the data recording/reproducing device; and
an engagement portion extended in a horizontal direction from the edges of the body to engage with the first vibration prevention member.

14. An installing unit to install a data recording/reproducing device on a photo-printer body, the installing unit comprising:
a supporting bracket to support the data recording/reproducing device; and
a vibration prevention member to support the supporting bracket on the photo-printer body to reduce transmission of an impact or a vibration generated from the photo-printer to the supporting bracket.

15. The installing unit as claimed in claim 14, wherein the vibration prevention member comprises a plurality of vibration proof rubbers engaged with the photo-printer body to support the supporting bracket.

16. The installing unit as claimed in claim 15, wherein the vibration proof rubbers comprise four in number, and each pair of vibration proof rubbers is respectively disposed at edges of the supporting bracket.

17. A photo-printer, comprising:
a photo-printer body;
a data recording/reproducing device installed on the photo-printer body to record and reproduce data; and
a supporting bracket to support the data recording/reproducing device; and
a vibration prevention member to support the supporting bracket on the photo-printer body to reduce transmission of an impact or a vibration generated from the photo-printer to the supporting bracket.

18. The photo-printer as claimed in claim 17, further comprising:
a second vibration prevention member disposed between the supporting bracket and the data recording/reproducing device to absorb the impact or the vibration transmitted from the supporting bracket to the data recording/reproducing device.

19. The photo-printer as claimed in claim 18, wherein the photo-printer body comprises:
a lower case including a printing engine; and
a top cover to cover the lower case and to support the data recording/reproducing device.

20. The photo-printer as claimed in claim 19, wherein the data recording/reproducing device comprises a hard disk drive (HDD).

21. The photo-printer as claimed in claim 20, wherein the vibration prevention member comprises a plurality of vibration proof rubbers engaged with the photo-printer body to support the supporting bracket.

22. The photo-printer as claimed in claim 21, wherein the vibration proof rubbers comprise four in number, and each pair of vibration proof rubbers is respectively disposed at edges of the supporting bracket.

23. The photo-printer as claimed in claim 21, wherein the second vibration prevention member comprises a viscoelastic material disposed between the supporting bracket and the data recording/reproducing device.

24. The photo-printer as claimed in claim 18, wherein the second vibration prevention member comprises a viscoelastic material disposed between the supporting bracket and the data recording/reproducing device.
